(19) United States
(12) Patent Application Publication
(10) Pub. No.: US 2026/0320707 A1
(43) Pub. Date: Oct. 15, 2026

(54) DEVICE AND METHOD FOR CONTROLLING A FOOD DELIVERY SYSTEM

(71) Applicant: GrabTaxi Holdings Pte. Ltd., Singapore (SG)

(72) Inventors: Saiya JIANG, Singapore (SG); Chirayu Dileep Kumar BELTHUR, Singapore (SG); Prashant KUMAR, Singapore (SG); Louis Reinaldo Raharja HADIATMAJAYA, Singapore (SG); Chunkai PHANG, Singapore (SG)

(21) Appl. No.: 19/117,089

(22) PCT Filed: Sep. 19, 2023
(86) PCT No.: PCT/SG2023/050637

§ 371 Date: Mar. 31, 2025

(30) Foreign Application Priority Data
Oct. 3, 2022 (SG) 10202251239K

(51) Int. Cl. G06Q 50/12; G06Q 10/0834; G06Q 30/0202

(52) U.S. Cl. CPC G06Q 50/12; G06Q 10/08345; G06Q 30/0202

(57) ABSTRACT

Aspects concern a method for controlling a food delivery system, comprising determining, from historical data, information about a dependency of a ratio of an amount of food delivery requests to a demand for food delivery from at least one parameter comprising at least one of a food delivery fare and an estimated food delivery time, determining an amount of food delivery requests which can be served, predicting a demand for food delivery, determining a target ratio of an amount of food delivery requests to a demand for food delivery, wherein the target ratio is determined such that the amount of requests which result, according to the target ratio, from the predicted demand, can be served by the determined amount of requests, determining one or more values for the at least one parameter which, according to the determined dependency, result in the target ratio and transmitting food delivery information in accordance with the determined one or more values for the at least one parameter to customers of the food delivery system.

### TECHNICAL FIELD

Various aspects of this disclosure relate to devices and methods for controlling a food delivery system.

### BACKGROUND

Due to development of information technology, a user may request an on-demand service using a computing device. The on-demand service may allow the user to fulfil the user's demand via an immediate access to goods and/or services. The user may request the on-demand service, such as a delivery service or a transport service, using a user interface presented on the computing device.

As an example, the user may request a search for the on-demand service, for example, a food delivery order, using the computing device. A server providing the on-demand service may then aggregate locations of available service providers (e.g. restaurants), types of services available (e.g. foods), estimated fees and other information, and provide the aggregated information to the computing device, so that the user can make selections on the user interface presented on the computing device. Once the user makes the selections on the user interface, the server may allocate a service contractor (e.g. driver) among a plurality of service contractors to deliver the selected food from the selected restaurant to the user.

While the demand for the on-demand service swings heavily from time to time, the number of the plurality of service contractors may tend to remain relatively constant. For example, during peak hours (for example, lunch time and dinner time), the demand may surpass a supply level by far. Conventionally, as a solution, on-demand service platforms may batch multiple orders to fulfil the demand as much as possible. As another solution, the on-demand service platforms may reduce the delivery radius. The delivery radius may be reduced based on a confirmed allocation rate of a plurality of orders received in a region where the user is located in. If the confirmed allocation rate is low, the on-demand service platforms may reduce the delivery radius to control a visibility of the service providers, in order to allow only a short distance delivery.

This, however, may result in merchants (e.g. restaurants) to become unavailable for customers (which are located within the normal delivery radius but outside of the reduced delivery radius). This may be annoying for these customers and lead to the fact that the customers perceive the service as being unreliable and may not use the service at all.

Therefore, approaches for shaping demand which allow maintain merchant availability during supply crunch are desirable.

### SUMMARY

Various embodiments concern a method for controlling a food delivery system, including determining, from historical data, information about a dependency of a ratio of an amount of food delivery requests to a demand for food delivery from at least one parameter including at least one of a food delivery fare and an estimated food delivery time, determining an amount of food delivery requests which can be served, predicting a demand for food delivery, determining a target ratio of an amount of food delivery requests to a demand for food delivery, wherein the target ratio is determined such that the amount of requests which result, according to the target ratio, from the predicted demand, can be served by the determined amount of requests, determining one or more values for the at least one parameter which, according to the determined dependency, result in the target ratio and transmitting food delivery information in accordance with the determined one or more values for the at least one parameter to customers of the food delivery system.

According to one embodiment, the at least one delivery parameter includes the food delivery fare and transmitting the food delivery information includes transmitting the determined one or more values for the food delivery fare to the customers of the food delivery system.

According to one embodiment, the at least one delivery parameter includes the estimated food delivery time and transmitting the food delivery information includes transmitting the determined one or more values for the estimated food delivery time to the customers of the food delivery system.

According to one embodiment, the at least one delivery parameter includes at least one of the food delivery fare and the estimated food delivery time and includes an availability of food delivery providers.

According to one embodiment, transmitting the food delivery information includes transmitting information, for each of a plurality of food delivery service providers, whether the food delivery service provider is available.

According to one embodiment, the one or more values for the availability of the food delivery providers include a delivery range of the food delivery providers.

According to one embodiment, the one or more values indicate a category of the at least one parameter among a plurality of predetermined categories of the at least one parameter.

According to one embodiment, the method includes receiving a signal predictive of demand for food delivery and predicting the demand for food delivery based on the received signal predictive of demand for food delivery.

According to one embodiment, the signal predictive of demand is an amount of sessions of an application for issuing food delivery requests currently performed by users.

According to one embodiment, the method includes receiving a signal predictive of supply for food delivery and determining the amount of food delivery requests which can be served based on the received signal predictive of supply for food delivery.

According to one embodiment, the signal predictive of supply of supply for food delivery is a number of food delivery drivers available for food delivery providers.

According to one embodiment, the at least one delivery parameter includes both the food delivery fare and the estimated food delivery time, the method includes determining one or more values for each of the food delivery fare and the estimated food delivery time which, according to the determined dependency, result in the target ratio and transmitting food delivery information in accordance with the determined one or more values for each of the food delivery fare and the estimated food delivery time to customers of the food delivery system.

According to one embodiment, the method includes, if the target ratio is higher than a current ratio of an amount of food delivery requests to a demand for food delivery which results of one or more current values for the food delivery fare and one or more values for the estimated food delivery time, prioritising, for determining the one or more values for the food delivery fare and for the estimated food delivery time, increasing the one or more current values for the estimated food delivery time over increasing the one or more current values for the food delivery fare.

According to one embodiment, the method includes, if the target ratio is lower than a current ratio of an amount of food delivery requests to a demand for food delivery which results of one or more current values for the food delivery fare and one or more values for the estimated food delivery time, prioritising, for determining the one or more values for the food delivery fare and for the estimated food delivery time, decreasing the one or more current values for the food delivery fare over decreasing the one or more current values for the estimated food delivery time.

According to one embodiment, the at least one parameter includes a plurality of parameters and wherein the information about the dependency of a ratio of an amount of food delivery requests to a demand for food delivery from the at least one parameter is a table which includes an entry for the ratio of an amount of food delivery requests to a demand for food delivery for multiple combinations of values of different ones of the plurality of parameters.

According to one embodiment, a computer program element is provided including program instructions, which, when executed by one or more processors, cause the one or more processors to perform the method for controlling a food delivery system described above.

According to one embodiment, a computer-readable medium is provided including program instructions, which, when executed by one or more processors, cause the one or more processors to perform the method for controlling a food delivery system described above.

### BRIEF DESCRIPTION OF THE DRAWINGS

The invention will be better understood with reference to the detailed description when considered in conjunction with the non-limiting examples and the accompanying drawings, in which:

FIG. 1 shows a communication arrangement including a smartphone and a server.

FIG. 2 shows a conversion rate matrix for each of four geographical regions.

FIG. 3 illustrates an approach for demand shaping using ETA (estimated time of arrival) and fare according to an embodiment.

FIG. 4 shows a flow diagram for demand shaping according to an embodiment.

FIG. 5 shows a flow diagram illustrating a method for controlling a food delivery system according to an embodiment.

FIG. 6 shows a server computer according to an embodiment.

### DETAILED DESCRIPTION

The following detailed description refers to the accompanying drawings that show, by way of illustration, specific details and embodiments in which the disclosure may be practiced. These embodiments are described in sufficient detail to enable those skilled in the art to practice the disclosure. Other embodiments may be utilized and structural, and logical changes may be made without departing from the scope of the disclosure. The various embodiments are not necessarily mutually exclusive, as some embodiments can be combined with one or more other embodiments to form new embodiments.

Embodiments described in the context of one of the devices or methods are analogously valid for the other devices or methods. Similarly, embodiments described in the context of a device are analogously valid for a vehicle or a method, and vice-versa.

Features that are described in the context of an embodiment may correspondingly be applicable to the same or similar features in the other embodiments. Features that are described in the context of an embodiment may correspondingly be applicable to the other embodiments, even if not explicitly described in these other embodiments. Furthermore, additions and/or combinations and/or alternatives as described for a feature in the context of an embodiment may correspondingly be applicable to the same or similar feature in the other embodiments.

In the context of various embodiments, the articles “a”, “an” and “the” as used with regard to a feature or element include a reference to one or more of the features or elements.

As used herein, the term “and/or” includes any and all combinations of one or more of the associated listed items.

In the following, embodiments will be described in detail.

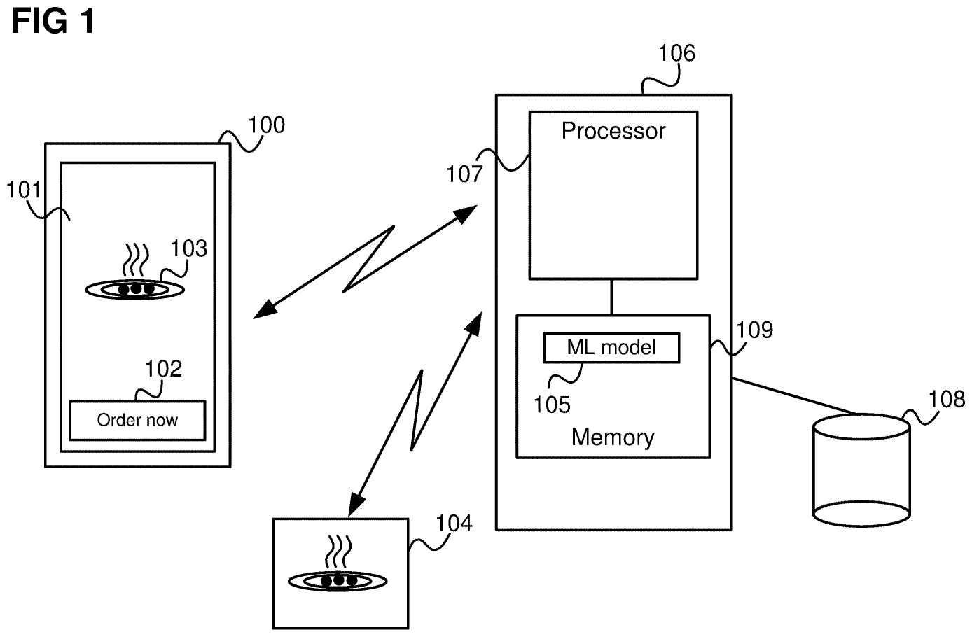

FIG. 1 shows a communication arrangement including a smartphone 100 and a server (computer) 106.

The smartphone 100 has a screen showing the graphical user interface (GUI) of an app for using one or more of various services, such as ordering food or e-hailing, which the smartphone's user has previously installed on his smartphone and has opened (i.e. started) to use the service, e.g. to order food.

The GUI 101 includes graphical user interface elements 102, 103 helping the user to use the service, e.g. a map of a vicinity of the user's position, food available in the user's vicinity (which the app may determine based on a location service, e.g. a GPS-based location service), a button for placing an order, etc.

When the user has made a selection for a service, e.g. a selection of a restaurant and/or a selection of food to order, the app communicates with a server 106 of the respective service via a radio connection. The server 106 (carrying out a corresponding server program by means of a processor 107) may consult a memory 109 or a data storage 108 having information regarding the service (e.g. prices (which include the price for the food and the fare for delivery), availability (including availability of drivers for performing the delivery), estimated time for delivery (ETA) etc.) The server communicates any data relevant or requested by the user (such as price (including explicitly or implicitly delivery fare) and estimated time for delivery) back to the smartphone 100 and the smartphone 100 displays this information on the GUI 101. The user may finally accept a service, e.g. order food. In that case, the server 106 informs the service provider 104, e.g. a restaurant or online supermarket accordingly. The server 106 may also communicate earlier with the service provider 104, e.g. for determining the estimated time for delivery.

It should be noted while the server 106 is described as a single server, its functionality, e.g. for providing a certain service and advertisement data will in practical application typically be provided by an arrangement of multiple server computers (e.g. implementing a cloud service). Accordingly, the functionality described in the following provided by a server (e.g. server 106) may be understood to be provided by an arrangement of servers or server computers.

Typically, there are periods where there is a higher demand for a service (e.g. lunch time for a food delivery service) and periods with lower demand (e.g. late at night for a food delivery service). So, during peak hours, demand may be higher than supply, i.e. there may be a supply crunch. This may lead to service providers, such as restaurant, become heavily overloaded and a lack of drivers.

One way to avoid this is to reduce the delivery radius of a certain service provider (e.g. restaurant 104). This, however, may result in merchants (e.g. restaurants) to become unavailable for customers (which are located within the normal delivery radius but outside of the reduced delivery radius). For example, the merchant may be indicated as being unavailable on the GUI 101 or may not be displayed at all when the user searches for restaurants to order from. This loss of unavailability of a service provider (with which the customer is familiar or which the customer may even regularly use) may be highly annoying for the customers and lead to the fact that the customer perceives the service (e.g. food delivery service) as being unreliable and may quit using the service. Even if only some service providers are listed as unavailable when the customer does a search this may reduce confidence of the customer in the service and may reduce the customer's willingness to use the service. In fact, real-life data shows that conversion rate (i.e. the ratio between amount of orders to the demand for the service as e.g. represented by the number of sessions of the app for ordering food) drops steeply when a certain number (e.g. around 30%) of unavailable results are displayed to customers.

Since consumers have a higher chance to check out in searches when their familiar merchants are displayed in result and merchants may be unavailable due to out of delivery radius, an approach is to relax the radius or reduce temporary close time of familiar merchants (which may also be a reasons for unavailability) for consumers with low interest to order from unfamiliar merchants. When familiar merchants are not available due to out of service hours, a customer may also recommend similar merchants to familiar merchants when the consumers exits a search session without placing an order. However, both of these approaches may not be sufficient to avoid that customers are unsatisfied (and do not use the service at all) or may not be easily applied or have other drawbacks, in particular when there is a supply crunch which needs to be handled.

In view of the above, according to various embodiments, approaches for shaping demand which allow maintaining merchant availability during a supply crunch, i.e. which avoid (or at least do not solely rely on) reduction of the delivery radius of service providers, are provided.

According to various embodiments, demand is shaped using fare (i.e. the price of delivery), ETA (estimated time of arrival) and availability. In this context, it should be noted that between ETA and fare, real-life data shows that customers are less sensitive to ETA than fare i.e. given availability, customers would rather pay less fare and wait a little longer than pay higher fare. Higher fare has a much adverse effect on conversion rate than longer ETA.

The biggest lever to affect conversion rate (i.e. the ratio between amount of requests for food delivery issued and “general” demand for food delivery as for example expressed by the number of users using a food delivery app at a certain point in time) is availability. High rates of unavailability (e.g. when less than 50% of available merchants are available), the conversion rate is low. Short ETA and low fare does not seem to compensate for availability, hence cannot boost demand themselves. Real-life data shows that customers can tolerate medium unavailability (below 30%) as long as they don't have to pay more.

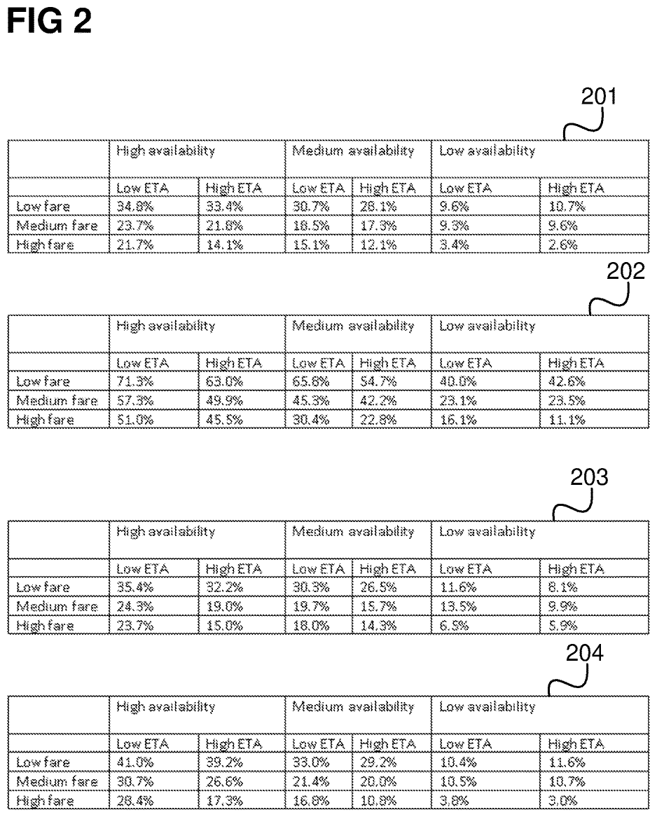

Customer sensitivity may be different across different markets (e.g. regions or countries). Therefore, according to various embodiments, conversion rates in dependency of the three demand shaping parameters mentioned above, i.e. fare, ETA and availability. These may for example be represented as a CVR (conversion rate) matrix as illustrated in FIG. 2.

FIG. 2 shows a CVR matrix for a first (geographical) region 201, a CVR matrix for a second region 202, a CVR matrix for a third region 203 and a CVR matrix for a fourth region 204. The geographical regions may be countries but also smaller regions (like cities, districts etc.)

Each CVR matrix (which can also be seen as a table) has an entry specifying a conversion rate (determined from historical data) for a combination of fare, ETA and availability.

In the examples of FIG. 2, there are three categories of fare (low, medium, high), there categories of availability (low, medium, high) and two categories of ETA (low and high). The ranges of these categories (i.e. what values qualify as “low” etc.) may be defined based on historical values (e.g. the lower third of historical fare values (e.g. for a certain range of delivery distances) is qualified as “low” fare). Finer granularities may also be used (i.e. more than two or three categories per parameter) or there even models of the dependency of the conversion rate from the parameters may be established.

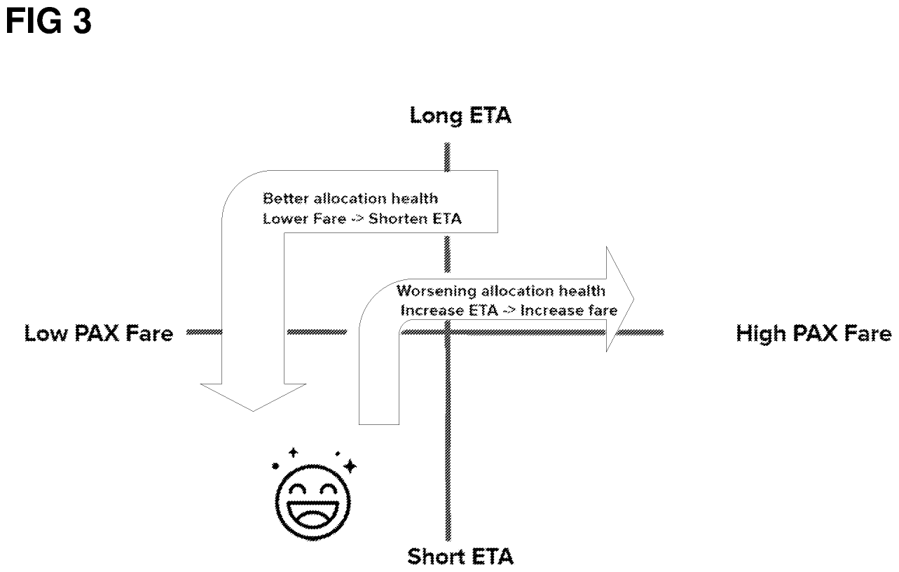

While availability may effectively shape demand, it may be desirable, as mentioned above, to maintain a certain level of service provider availability (e.g. with the goal of service reliability). Therefore to maintain a certain level of service provider availability, at least in certain scenarios demand is shaped using ETA and fare (e.g. when mismatch between supply and demand is not too high and thus ETA and fare are sufficient to shape demand). Since customers are more sensitive towards high fare than long ETA, according to various embodiments, demand is shaped according to an approach as illustrated in FIG. 3.

FIG. 3 illustrates an approach for demand shaping using ETA and fare according to an embodiment.

As illustrated, when allocation health starts to get worse (i.e. demand starts to exceed supply), ETA padding (i.e. increase of ETA) is used first followed by increase of fare if allocation health continues to be bad to minimize demand loss.

Once allocation health starts to recover, first fares are reduced and then ETA padding is removed since this allows CVR to recover faster.

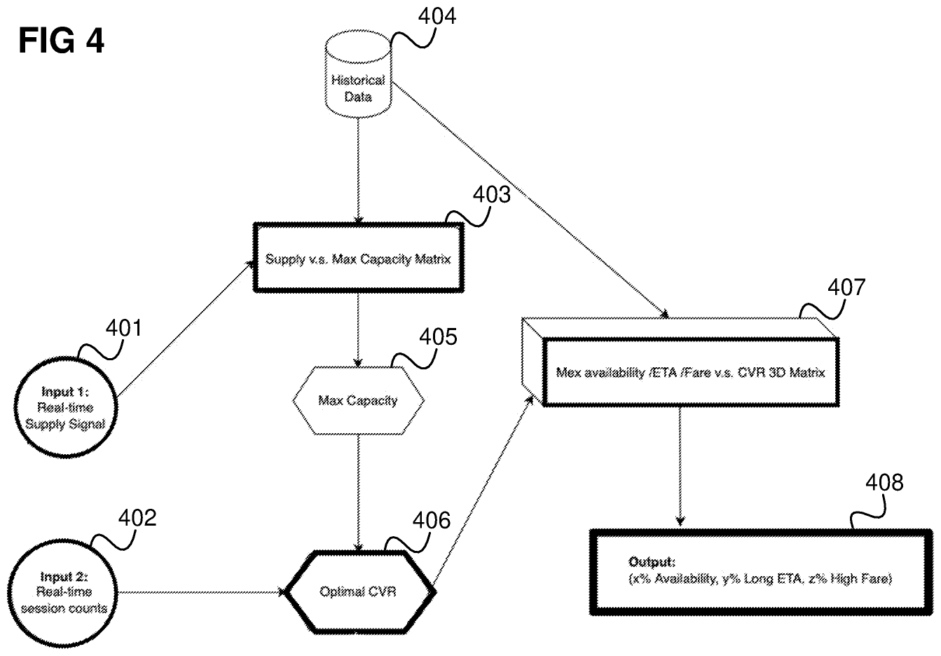

FIG. 4 shows a flow diagram 400 for demand shaping according to an embodiment.

First, a signal predictive of supply 401 and a signal predictive of demand 402 are obtained. For example, the server 106 may receive, in real time, a supply signal indicating the number of drivers within a predetermined distance of the merchant location as signal predictive of supply 401 and a signal indicating the number of app sessions (i.e. the number of users currently searching for service providers using the smartphone app) as signal predictive of demand 402. It should be noted that the signal predictive of demand is predictive of the “general” demand for food delivery while the demand that is shaped is the actual number of requests which results from this general demand and the conversion rate.

It should further be noted that the signal 401, 402 are, according to various embodiments, chosen to be independent in the sense that they are not affected by demand shaping. For example, a real-time CAR (confirmed allocation rate) signal (i.e. a real-time signal reflecting allocation status of incoming orders in, for example, the past 10 minutes which helps timely identifying the balance between demand and supply) and a signal indicating incoming orders are affected by demand shaping actions. In contrast, the number of nearby drivers and the number of app sessions are independent from demand shaping actions (e.g. customers are not aware of app content before they decide to launch the app).

In 403, the server 106 determines a maximum capacity 405, i.e. a maximum number of orders that can be allocated in a certain time window (e.g. the next a few minutes) based on the real-time supply signal (i.e. signal predictive of supply) 401. Further, the server determines from historical data 404 a dependency of CVR to availability, ETA and fare, e.g. in form of a CVR matrix as described with reference to FIG. 2 (or in form or another model determined (e.g. trained) on the historical data). As explained, when using a matrix, the different demand dampening (or shaping) tools (i.e. parameters) correspond to the dimensions and the matrix may be different across markets. It may be determined from historical data (historical patterns) of a certain time period.

From the maximum capacity 405, the server further determines a target CVR: given the maximum number of orders that can be allocated (i.e. served) and the predicted demand (i.e. the number of sessions from the signal predictive of demand 402), since incoming orders=number of sessions*CVR, the server 106 determines a target CVR (to be maintained) at some level to meet the maximum capacity 405 (i.e. incoming orders=maximum capacity) to avoid demand loss or low allocation rate.

In 407, the server 106 then determines a demand shaping measure given the target CVR 406 and the correlation (i.e. dependency) of CVR with the demand dampening tools. This means that using the information about the dependency of CVR from availability, ETA and fare (as e.g. given by the CVR matrix) the server 106 determines values 408 according to which information is to be provided to the customers (i.e. to be displayed on the GUI 101) for availability, ETA and fare (e.g. in accordance with percentages etc. it determines for these values).

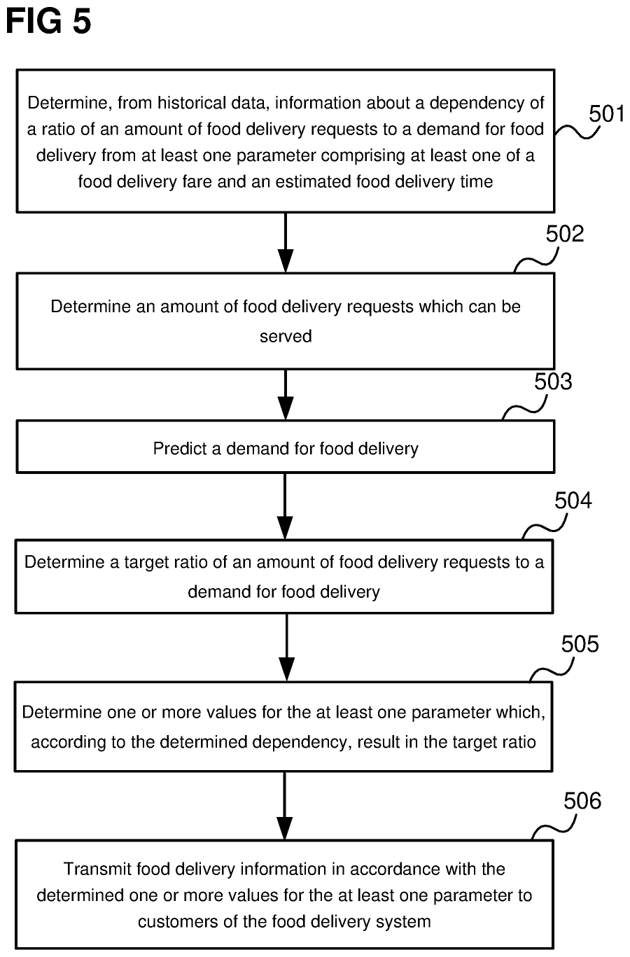

According to one embodiment, a method is provided as illustrated in FIG. 5.

FIG. 5 shows a flow diagram illustrating a method for controlling a food delivery system according to an embodiment.

In 501, information about a dependency of a ratio of an amount of food delivery requests to a demand for food delivery from at least one parameter including at least one of a food delivery fare and an estimated food delivery time is determined from historical data.

In 502, an amount of food delivery requests which can be served is determined, e.g. based on (further) historical data such as historical supply-demand balance.

In 503, a demand for food delivery is predicted.

In 504, a target ratio of an amount of food delivery requests to a demand for food delivery is determined, wherein the target ratio is determined such that the amount of requests which result, according to the target ratio, from the predicted demand, can be served by the determined amount of requests.

In 505, one or more values for the at least one parameter are determined which, according to the determined dependency, result in the target ratio.

In 506, food delivery information in accordance with the determined one or more values for the at least one parameter is transmitted to customers (i.e. to terminal devices, for example to computers or mobile devices, of the customers) of the food delivery system.

According to various embodiments, in other words, at least one of a delivery fare and delivery time (i.e. how long it takes for requested food to be delivered, e.g. in the form of an ETA) are set to achieve a certain target conversion rate (i.e. the target ratio) which is determined such that the resulting amount of requests can be served.

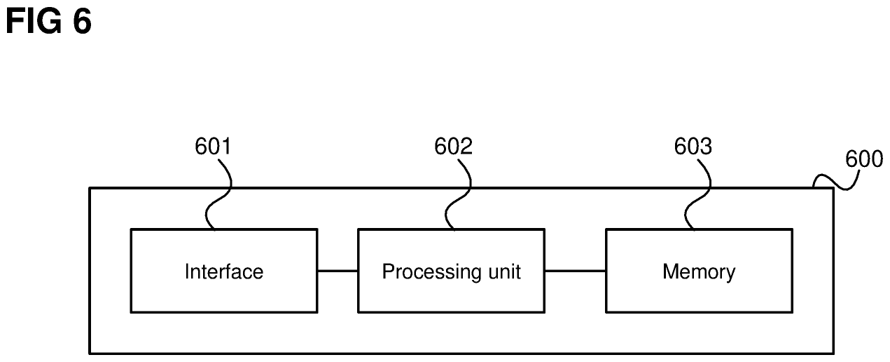

The method of FIG. 5 is for example carried out by a server computer as illustrated in FIG. 6.

FIG. 6 shows a server computer 600 according to an embodiment.

The server computer 600 includes a communication interface 601 (e.g. configured to receive data regarding demand and supply). The server computer 600 further includes a processing unit 602 and a memory 603. The memory 603 may be used by the processing unit 602 to store, for example, data to be processed, such as information about demand and supply. The server computer is configured to perform the method of FIG. 5.

The methods described herein may be performed and the various processing or computation units and the devices and computing entities described herein may be implemented by one or more circuits. In an embodiment, a “circuit” may be understood as any kind of a logic implementing entity, which may be hardware, software, firmware, or any combination thereof. Thus, in an embodiment, a “circuit” may be a hard-wired logic circuit or a programmable logic circuit such as a programmable processor, e.g. a microprocessor. A “circuit” may also be software being implemented or executed by a processor, e.g. any kind of computer program, e.g. a computer program using a virtual machine code. Any other kind of implementation of the respective functions which are described herein may also be understood as a “circuit” in accordance with an alternative embodiment.

While the disclosure has been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

1. A method for controlling a food delivery system, comprising:
determining, from historical data, information about a dependency of a ratio of an amount of food delivery requests to a demand for food delivery from at least one parameter comprising at least one of a food delivery fare and an estimated food delivery time;
determining an amount of food delivery requests which can be served;
predicting a demand for food delivery;
determining a target ratio of an amount of food delivery requests to a demand for food delivery, wherein the target ratio is determined such that the amount of food delivery requests which result, according to the target ratio, from the predicted demand, can be served by the determined amount of food delivery requests;
determining one or more values for the at least one parameter which, according to the determined dependency, result in the target ratio; and
transmitting food delivery information in accordance with the determined one or more values for the at least one parameter to customers of the food delivery system.

2. The method of claim 1, wherein the at least one parameter includes the food delivery fare and transmitting the food delivery information includes transmitting the determined one or more values for the food delivery fare to the customers of the food delivery system.

3. The method of claim 1, wherein the at least one parameter includes the estimated food delivery time and transmitting the food delivery information includes transmitting the determined one or more values for the estimated food delivery time to the customers of the food delivery system.

4. The method of claim 1, wherein the at least one parameter includes at least one of the food delivery fare and the estimated food delivery time and includes an availability of food delivery providers.

5. The method of claim 4, wherein transmitting the food delivery information includes transmitting information, for each of a plurality of food delivery service providers, whether the food delivery service provider is available.

6. The method of claim 4, wherein the one or more values for the availability of the food delivery providers include a delivery range of the food delivery providers.

7. The method of claim 1, wherein the one or more values indicate a category of the at least one parameter among a plurality of predetermined categories of the at least one parameter.

8. The method of claim 1, comprising receiving a signal predictive of demand for food delivery and predicting the demand for food delivery based on the received signal predictive of demand for food delivery.

9. The method of claim 8, wherein the signal predictive of demand is an amount of sessions of an application for issuing food delivery requests currently performed by users.

10. The method of claim 1, comprising receiving a signal predictive of supply for food delivery and determining the amount of food delivery requests which can be served based on the received signal predictive of supply for food delivery.

11. The method of claim 10, wherein the signal predictive of supply of supply for food delivery is a number of food delivery drivers available for food delivery providers.

12. The method of claim 1, wherein the at least one delivery parameter includes both the food delivery fare and the estimated food delivery time, the method comprises determining one or more values for each of the food delivery fare and the estimated food delivery time which, according to the determined dependency, result in the target ratio and transmitting food delivery information in accordance with the determined one or more values for each of the food delivery fare and the estimated food delivery time to customers of the food delivery system.

13. The method of claim 12, comprising, if the target ratio is higher than a current ratio of an amount of food delivery requests to a demand for food delivery which results of one or more current values for the food delivery fare and one or more values for the estimated food delivery time, prioritising, for determining the one or more values for the food delivery fare and for the estimated food delivery time, increasing the one or more current values for the estimated food delivery time over increasing the one or more current values for the food delivery fare.

14. The method of claim 12, comprising, if the target ratio is lower than a current ratio of an amount of food delivery requests to a demand for food delivery which results of one or more current values for the food delivery fare and one or more values for the estimated food delivery time, prioritising, for determining the one or more values for the food delivery fare and for the estimated food delivery time, decreasing the one or more current values for the food delivery fare over decreasing the one or more current values for the estimated food delivery time.

15. The method of claim 1, wherein the at least one parameter comprises a plurality of parameters and wherein the information about the dependency of a ratio of an amount of food delivery requests to a demand for food delivery from the at least one parameter is a table which comprises an entry for the ratio of an amount of food delivery requests to a demand for food delivery for multiple combinations of values of different ones of the plurality of parameters.

16. A server computer for controlling a food delivery system comprising:
a radio interface;
memory interface; and
processing unit configured:
determine, from historical data, information about a dependency of a ratio of an amount of food delivery requests to a demand for food delivery from at least one parameter comprising at least one of a food delivery fare and an estimated food delivery time;
determine an amount of food delivery requests which can be served;
predict a demand for food delivery;
determine a target ratio of an amount of food delivery requests to a demand for food delivery, wherein the target ratio is determined such that the amount of food delivery requests which result, according to the target ratio, from the predicted demand, can be served by the determined amount of food delivery requests;
determine one or more values for the at least one parameter which, according to the determined dependency, result in the target ratio; and
transmit food delivery information in accordance with the determined one or more values for the at least one parameter to customers of the food delivery system.

17. (canceled)

18. A non-transitory computer-readable medium comprising program instructions, which, when executed by one or more processors, cause the one or more processors to perform a method for controlling a food delivery system, comprising:
determining, from historical data, information about a dependency of a ratio of an amount of food delivery requests to a demand for food delivery from at least one parameter comprising at least one of a food delivery fare and an estimated food delivery time;
determining an amount of food delivery requests which can be served;
predicting a demand for food delivery;
determining a target ratio of an amount of food delivery requests to a demand for food delivery, wherein the target ratio is determined such that the amount of food delivery requests which result, according to the target ratio, from the predicted demand, can be served by the determined amount of food delivery requests;
determining one or more values for the at least one parameter which, according to the determined dependency, result in the target ratio; and
transmitting food delivery information in accordance with the determined one or more values for the at least one parameter to customers of the food delivery system.
